(19) United States
(12) Patent Application Publication
(10) Pub. No.: US 2019/0004497 A1
(43) Pub. Date: Jan. 3, 2019

(54) TECHNOLOGIES OF CONTROLLING ADDITIVE MANUFACTURING SYSTEMS

(71) Applicants: Krister HÅKENRUD, Hønefoss (NO); Brede VIGDAL, Tyristrand (NO)

(72) Inventors: Krister HÅKENRUD, Hønefoss (NO); Brede VIGDAL, Tyristrand (NO)

(73) Assignee: NORSK TITANIUM AS, Hønefoss (NO)

(21) Appl. No.: 16/019,430

(22) Filed: Jun. 26, 2018

Related U.S. Application Data
(60) Provisional application No. 62/527,459, filed on Jun. 30, 2017.

(51) Int. Cl. G05B 19/4099; G05B 19/409; B29C 64/393; B29C 64/371

(52) U.S. Cl. CPC G05B 19/4099; G05B 19/409; B29C 64/393; B29C 64/371; B33Y 50/02; G05B 2219/13005; G05B 2219/36133; G05B 2219/49007; G05B 2219/23067

(57) ABSTRACT

A system/method for executing a program accessing a plurality of subroutines/libraries; invoking a first subroutine providing the program with axis data having offset values in accordance with a workpiece coordinate system; invoking a second subroutine providing the program with geometric data about a geometric of an additive manufacturing tool and setting a tool offset point of the tool at a distance above a substrate surface; receiving a workpiece identifier from an HMI; invoking a third subroutine providing the program with rapid plasma deposition part programming instructions and rapid plasma deposition features from one of the libraries based on the workpiece identifier; invoking a fourth subroutine verifying the instructions and the rapid plasma deposition features; and invoking a fifth subroutine enabling the program to request an additive manufacturing system to deposit a layer on the substrate surface by the additive manufacturing tool via the additive manufacturing process.

This application claims the priority benefit of U.S. Provisional Application No. 62/527,459 filed on Jun. 30, 2017, and which is hereby incorporated by reference in its entirety for all purposes as if fully set forth herein.

### BACKGROUND

### Technical Field

Generally, this disclosure relates to manufacturing systems. More particularly, this disclosure relates to process architectures for control of manufacturing systems.

### Discussion of Related Art

An additive manufacturing system, such as an additive metal deposition system or others, can rely on active feedback from a set of sensors in order to control, in real-time, a set of additive manufacturing parameters, such as a fed-stock rate, a stand-off distance, a plasma gas flow, a main current, a plasma transferred arc (PTA) current, a preheat current, or others. For example, an additive manufacturing system with an Interlayer Real-time Imaging and Sensing System (IRISS) technology includes a real-time adaptive control system that can sense and digitally self-adjust a metal deposition process with some degree of precision and repeatability. However, a technical problem exists when the active feedback from the set of sensors contains a large set of data. In particular, the large set of data is not only difficult to process in real-time, especially if data conflicts exist, but also can result in some uncontrolled variations in the set of additive manufacturing parameters during manufacturing, such as a traverse speed, a melt pool energy input, a thermal condition, or others. Such uncontrolled variations can result in some undesired workpiece characteristics, such as excessive material voids, low material strength, unwanted material properties, disproportionate material porosity, or others. Resultantly, the uncontrolled variations can have an adverse impact on an additive manufacturing workflow and on an ability to produce workpieces that have consistently repeatable material properties, which is especially important when seeking approval of safety regulators, such as in aerospace applications, automotive applications, medical applications, or others. Furthermore, when the additive manufacturing system includes a metal deposition system, then the technical problem becomes more complex as most conventional metal deposition processes are not repeatable over time on a same machine basis and across multiple machines. Accordingly, there is a need to solve these and other technical problems.

### SUMMARY

Accordingly, provided are various technologies for additive manufacturing systems that effectively minimize or avoid reliance on the active feedback from the set of sensors in order to control, in real-time, the set of additive manufacturing parameters and thereby substantially obviate the technical problems due to limitations and disadvantages, as noted above.

An advantage of various systems provided herein is to provide a manufacturing process, such as an additive manufacturing process or others, that involves a development of a set of executable-instructions for a workpiece to be manufactured. The set of executable-instructions is configuration-managed through a process control process, such as via following a standardized quality control process that regulates a development of the set of executable-instructions, a quality control of the set of executable-instructions, a release of the set of executable-instructions, an edit to the set of executable-instructions, or others. Once developed, the set of executable-instructions can be loaded into a machine interface of a manufacturing machine, such as a metal deposition machine or others, such that a plurality of workpieces can be manufactured with a set of consistent material properties. Additionally, as the manufacturing machine is calibrated to a common standard, the workpieces can be manufactured on other manufacturing machines.

Additional features and advantages of the systems provided herein will be set forth in a detailed description which follows, and in part will be apparent from the detailed description, or can be learned by practice of this disclosure. Various objectives and other advantages of this disclosure will be realized and attained by a structure particularly pointed out in the detailed description and claims hereof as well as in a set of appended drawings.

To achieve these and other advantages and in accordance with a purpose of this disclosure, as embodied and broadly described, a system comprises: a human machine interface (HMI) configured to receive a user input; a first programmable logic controller (PLC) in communication with the HMI; a second PLC in communication with the HMI and the first PLC, wherein the first PLC controls the second PLC, wherein the second PLC controls a machine configured to additively manufacture a structure via melting a wire in a cloud of an inert gas using a set of instructions based on the user input.

And in further accordance with a purpose of this disclosure, as embodied and broadly described a method comprising: executing, by a process master controller (104), a program (204) configured to access a plurality of subroutines (206) and a plurality of libraries (208); invoking, by the process master controller, via the program, a first subroutine (210) of the subroutines, wherein the first subroutine provides the program with a set of axis data with a plurality of offset values in accordance with a workpiece coordinate system (WCS); invoking, by the process master controller, via the program, a second subroutine (212) of the subroutines, wherein the second subroutine provides the program with a set of geometric data about a geometric of an additive manufacturing tool for an additive manufacturing process and sets a tool offset point of the additive manufacturing tool at a distance above a substrate surface; receiving, by the process master controller, via the program, a workpiece identifier from an HMI (110); invoking, by the process master controller, via the program, a third subroutine (214) of the subroutines, wherein the third subroutine provides the program with a set of rapid plasma deposition part programming instructions and a set of rapid plasma deposition features from one of the libraries based on the workpiece identifier; invoking, by the process master controller, via the program, a fourth subroutine (216) of the subroutines, wherein the fourth subroutine verifies the set of rapid plasma deposition part programming instructions and the set of rapid plasma deposition features; invoking, by the process master controller, via the program, a fifth subroutine (218) of the subroutines, wherein the fifth subroutine enables the program to request an additive manufacturing system to deposit a layer on the substrate surface by the additive manufacturing tool via the additive manufacturing process; and depositing the layer on the substrate surface with the additive manufacturing tool, under the control of the process master controller, in response to the additive manufacturing system request.

In further embodiments, the additive manufacturing process includes melting a wire via a torch in a cloud of an inert gas.

In further embodiments, the method further comprising: invoking, by the process master controller, via the program, the fourth subroutine after the layer has been deposited such that another layer can be deposited based on the set of rapid plasma deposition part programming instructions and the set of rapid plasma deposition features.

In further embodiments, the program is configured to receive an input from a user via the HMI, wherein the input is configured to request a simulation of the additive manufacturing system depositing the layer on the substrate surface by the additive manufacturing tool via the additive manufacturing process, and further comprising: receiving, by the process master controller, via the program, the input from the HMI; and performing, by the process master controller, the simulation.

In further embodiments, the additive manufacturing system deposits the layer on the substrate surface by the additive manufacturing tool via the additive manufacturing process without relying on an active feedback from a sensor.

In further embodiments, the program is specific a workpiece based on the workpiece identifier.

In further embodiments, the workpiece identifier is received without invoking the subroutines.

In further embodiments, at least one of the libraries is remote from the process master controller.

In further embodiments, the method further comprising: aborting, by the process master controller, the program during the third subroutine based on the program not being provided with the set of axis data with the plurality of offset values in accordance with the WCS, the set of geometric data about the geometric the additive manufacturing tool for the additive manufacturing process, and the workpiece identifier at that time.

In further embodiments, the additive manufacturing system deposits the layer on the substrate surface by the additive manufacturing tool via the additive manufacturing process based on: resetting from a previous layer, and determining a set of positions along the layer where a preheat torch, a melter torch, a PTA, and a rapid cooler in the additive manufacturing system will stop and start.

In yet further accordance with a purpose of this disclosure, as embodied and broadly described, a system comprising: an HMI (110); a process master controller (104) configured to: execute a program (204) configured to access a plurality of subroutines (206) and a plurality of libraries (208); invoke, via the program, a first subroutine (210) of the subroutines, wherein the first subroutine provides the program with a set of axis data with a plurality of offset values in accordance with a workpiece coordinate system (WCS); invoke, via the program, a second subroutine (212) of the subroutines, wherein the second subroutine provides the program with a set of geometric data about a geometric of an additive manufacturing tool for an additive manufacturing process and sets a tool offset point of the additive manufacturing tool at a distance above a substrate surface; receive, via the program, a workpiece identifier from the HMI; invoke, via the program, a third subroutine (214) of the subroutines, wherein the third subroutine provides the program with a set of rapid plasma deposition part programming instructions and a set of rapid plasma deposition features from one of the libraries based on the workpiece identifier; invoke, via the program, a fourth subroutine (216) of the subroutines, wherein the fourth subroutine verifies the set of rapid plasma deposition part programming instructions and the set of rapid plasma deposition features; and invoke, via the program, a fifth subroutine (218) of the subroutines, wherein the fifth subroutine enables the program to request an additive manufacturing system to deposit a layer on the substrate surface by the additive manufacturing tool via the additive manufacturing process.

In further embodiments, the additive manufacturing process includes melting a wire via a torch in a cloud of an inert gas.

In further embodiments, the process master controller is further configured to: invoke, via the program, the fourth subroutine after the layer has been deposited such that another layer can be deposited based on the set of rapid plasma deposition part programming instructions and the set of rapid plasma deposition features.

In further embodiments, the program is configured to receive an input from a user via the HMI, wherein the input is configured to request a simulation of the additive manufacturing system depositing the layer on the substrate surface by the additive manufacturing tool via the additive manufacturing process, and the process master controller is further configured to: receive, via the program, the input from the HMI; and perform the simulation.

In further embodiments, the additive manufacturing system deposits the layer on the substrate surface by the additive manufacturing tool via the additive manufacturing process without relying on an active feedback from a sensor.

In further embodiments, the program is specific a workpiece based on the workpiece identifier.

In further embodiments, the workpiece identifier is received without invoking the subroutines.

In further embodiments, at least one of the libraries is remote from the process master controller.

In further embodiments, the process master controller is further configured to: abort the program during the third subroutine based on the program not being provided with the set of axis data with the plurality of offset values in accordance with the WCS, the set of geometric data about the geometric the additive manufacturing tool for the additive manufacturing process, and the workpiece identifier at that time.

In further embodiments, the additive manufacturing system deposits the layer on the substrate surface by the additive manufacturing tool via the additive manufacturing process based on: resetting from a previous layer, and determining a set of positions along the layer where a preheat torch, a melter torch, a PTA, and a rapid cooler in the additive manufacturing system will stop and start.

The present disclosure discloses various technical solutions to various technical problems identified above. These technical solutions solve these technical problems in various unconventional ways. For example, in some embodiments, employing a program with access to subroutines and libraries, where the program invokes the subroutines and the subroutines interface with the libraries, enables reduction of active feedback from sensors in order to control various manufacturing parameters, in real-time. Likewise, in some embodiments, employing the program enables configuration-management that provides manufacturing standardization, workpiece consistency, and repeatability across multiple machines. Similarly, in some embodiments, employing the program reduces data conflicts since the program employs the subroutines and the libraries that are programmed to avoid or minimize such data conflicts based on input workpiece identifiers.

It is to be understood that both the foregoing general description and the following detailed description are exemplary and explanatory and are intended to provide further explanation of claims, as further recited below.

### BRIEF DESCRIPTION OF DRAWINGS

The set of appended drawings, which are included to provide a further understanding of this disclosure and are incorporated in and constitute a part of this specification, illustrate embodiments of this disclosure and together with the detailed description serve to explain various principles of this disclosure.

In the set of appended drawings:

FIG. 1 is a block diagram of an embodiment of a control hierarchy and distribution schema of a manufacturing system according to this disclosure.

FIG. 2 is a block diagram of an embodiment of a logic architecture according to this disclosure.

FIG. 3 is a flowchart of an embodiment of a process for executing a logic for additive manufacturing according to this disclosure.

FIG. 4 is a flowchart of an embodiment of a define jig function process according to this disclosure.

FIG. 5 is a flowchart of an embodiment of a define deposition tool function process according to this disclosure.

FIG. 6 is a flowchart of an embodiment of a data check function process according to this disclosure.

FIG. 7 is a flowchart of an embodiment of a read data function process according to this disclosure.

FIG. 8 is a flowchart of an embodiment of a run string function process according to this disclosure.

FIG. 9 is a flowchart of an embodiment of a dry run function process according to this disclosure.

FIG. 10 is a flowchart of an embodiment of a temperature process according to this disclosure.

FIG. 11 is a flowchart of an embodiment of a temperature process according to this disclosure.

### DETAILED DESCRIPTION OF ILLUSTRATED EMBODIMENTS

This disclosure is now described more fully with reference to the set of accompanying drawings, in which some embodiments of this disclosure are shown. This disclosure can, however, be embodied in many different forms and should not be construed as necessarily being limited to the embodiments disclosed herein. Rather, these embodiments are provided so that this disclosure is thorough and complete, and fully conveys various concepts of this disclosure to skilled artisans. Reference will now be made in detail to an embodiment of this disclosure, an example of which is illustrated in the set of appended drawings.

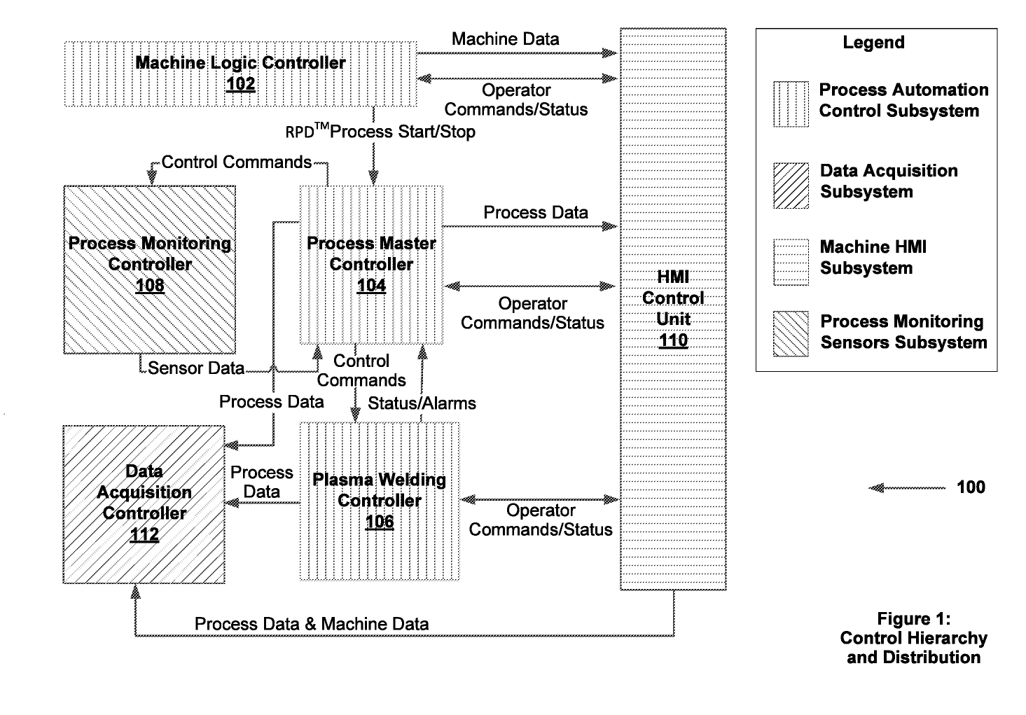

FIG. 1 is a block diagram of an embodiment of a control hierarchy and distribution schema of a manufacturing system according to this disclosure. In particular, a control hierarchy and distribution schema 100 of an additive manufacturing system is disclosed. For example, the additive manufacturing system can include a metal deposition system, a 3-D printing system, or others. For example, the metal deposition system can be configured to deposit a metal, an alloy, or others, including combinations thereof. For example, the metal can include titanium or others, or the metal alloy can include steel, brass, bronze, or others. For example, the metal deposition system can include a rapid plasma deposition system, such as where a metal in a wire form, such as a wire including titanium or others, is melted in a cloud of an inert gas, such as argon or others, and precisely and rapidly built up in layers via a robotic layer-building process to a near-net-shape, such as up to 80% complete or even more, that requires minimum finish machining. For example, the metal deposition system may be a system such as disclosed in U.S. patent application Ser. No. 15/206,163; and U.S. Pat. Nos. 7,301,120; 7,326,377; 9,346,116; and 9,481,931; all of which are hereby fully incorporated by reference herein for all purposes. For example, the metal deposition system can be configured for at least one of a solid free form deposition, an additive deposition, a 3D deposition, or others. For example, the metal deposition system can include a Merke IV machine from Norsk Titanium, which is able to receive a file of a workpiece design, such as a computer-aided design (CAD) file or others, and a spool of a wire, such as a wire including titanium or others, and produce a workpiece, which can be aerospace-grade or others, based on a specific workpiece geometry, as extracted from the file of the workpiece design. For example, the metal deposition system can be encased in or include a chamber filled with an inert gas, such as argon, helium, xenon, krypton, or combinations thereof. For example, the 3-D printing system can be configured to additively deposit a plastic or others. Note though that non-additive manufacturing system can be used as well, such as a subtractive manufacturing system or others.

The control hierarchy and distribution schema 100 includes a plurality of subsystem blocks, including a process automation control subsystem block, a data acquisition subsystem block, a machine HMI subsystem block, and a process monitoring sensors subsystem block. Note that other subsystems blocks are possible, such as a data security subsystem block or others. The process automation control subsystem block includes a machine logic controller 102, a process master controller 104, and a plasma welding controller 106. The data acquisition subsystem block includes a data acquisition controller 112. The machine HMI subsystem block includes an HMI control unit 110. The process monitoring sensors subsystem block includes a process monitoring controller 108.

The machine logic controller 102 can be embodied as hardware, such as a set of circuitry in any form, such as a PLC, or software, such as a set of executable instructions in any form, such as an executable code. The machine logic controller 102 communicably interfaces with the HMI control unit 110 and the process master controller 104. The machine logic controller 102 acts as a machine control master handling a set of machine states, maintaining an inert atmosphere required for a material deposition process, and handling a set of safety parameters. The machine logic controller 102 employs the process master controller 104 for activities related to the material deposition process. Apart from these, most or all mechanical drives and axis coordinates are controlled by the process master controller due to various input/output (TO) constraints and performance requirements. In such cases, the machine logic controller 102 calls a set of corresponding functions as and when required, whether the set of corresponding functions is stored local to or remote from the machine logic controller 102.

The process master controller 104 can be embodied as hardware, such as a set of circuitry in any form, such as a PLC, or software, such as a set of executable instructions in any form, such as an executable code. The process master controller 104 communicably interfaces with the HMI control unit 110, the plasma welding controller 106, the data acquisition controller 112, the process monitoring controller 108, and the machine logic controller 102. The process master controller 104 handles some, most, or all material deposition process related activities, such as parsing a material deposition set of executable instructions, controlling a set of positioning equipment, controlling a wire feed, controlling a process thermal input, monitoring a process parameter, controlling a process parameter, accessing a feature library in a data store, accessing a weld recipe in a data store, and handles some, most, or all connected mechanical drives and axis coordinates when commanded by the machine logic controller 102.

The plasma welding controller 106 can be embodied as hardware, such as a set of circuitry in any form, such as a PLC, or software, such as a set of executable instructions in any form, such as an executable code. The plasma welding controller 106 communicably interfaces with the process master controller 104, the HMI control unit 110, and the data acquisition controller 112. The plasma welding controller 106 acts as commanded via the process master controller 104 to control a set of plasma welding parameters related to a master wire feeding subsystem, an inverter subsystem, a gas control subsystem, a tool cooling subsystem or others, any of which can communicably interface with the plasma welding controller 106.

The process monitoring controller 108 can be embodied as hardware, such as a set of circuitry in any form, such as a PLC, or software, such as a set of executable instructions in any form, such as an executable code. The process monitoring controller 108 communicably interfaces with the process master controller 104. For example, the process monitoring controller 108 can include an image capture device, such as a camera or others, such as a line scanner or others, which can include a laser line scanner or others. For example, the process monitoring controller 108 can include a logic, whether hardware or software, that is configured to enable an observatory automation system, such as Chimera or others, and configured to store data to a memory, whether volatile or non-volatile, such as a data structure, a database, a network drive, or others as part of data logging. For example, the data structure can include an array or others. For example, the database can be relational, in-memory, graphical, or others. For example, the network drive can be of any type direct-attached storage (DAS) or network-attached storage (NAS) on any network, such as a local area network (LAN), a storage area network (SAN), a wide area network (WAN), or others, whether radio, optical, acoustic, wired, wireless, or others. For example, the process monitoring controller 108 can include a thermometer, which can be remote sensing or others, such as a pyrometer or others, such as an infrared (IR) pyrometer or others. The process monitoring controller 108 can handle a request from the process master controller 104 to output data acquired from a process monitoring sensor, such as an IR pyrometer, a laser line scanner, an observatory automation system, or others.

The HMI control unit 110 can be embodied as hardware, such as a set of circuitry in any form, such as a PLC, or software, such as a set of executable instructions in any form, such as an executable code. The HMI control unit 110 communicably interfaces with the machine logic controller 102, the process master controller 104, the plasma welding controller 106, and the data acquisition controller 112. The HMI control unit 110 hosts a machine interface to a material deposition system, such as a touch-display, a peripheral, a control panel, a keyboard, a mobile device, or others. As such, the HMI control unit 110 is configured to command, parameterize, and monitor a machine state and a material deposition parameter, such as a sensor parameter or others. The HMI control unit 110 hosts a server, whether hardware or software, such as an Open Platform Communication (OPC) server, which acts as a data exchange gateway to the machine logic controller 102 and the process master controller 104. For example, such server can communicably interface with (1) a PLC controlling a hardware device and (2) a client, whether hardware or software, hosting a logic configured for an OPC communication, where the server translates between a communication protocol of the PLC and an OPC protocol of the logic. For example, the client uses the server to get data from or send commands to the hardware device through the PLC. Note that the client and the server can be configured in various ways, such as an OPC aggregation technique, an OPC tunneling technique, an OPC bridging technique, an OPC Data Hub technique, or others. Further, note that the server can be configured for data logging and storage by the data acquisition subsystem.

The data acquisition controller 112 can be embodied as hardware, such as a set of circuitry in any form, such as a PLC, or software, such as a set of executable instructions in any form, such as an executable code. The data acquisition controller 112 communicably interfaces with the process master controller 104, the plasma welding controller 106, and the HMI control unit 110. The data acquisition controller 112 is configured to receive a first set of process data from the process master controller 104, a second set of process data from the plasma welding controller 106, a third set of process data from the HMI controller unit 110, and a set of machine data from the HMI control unit 110.

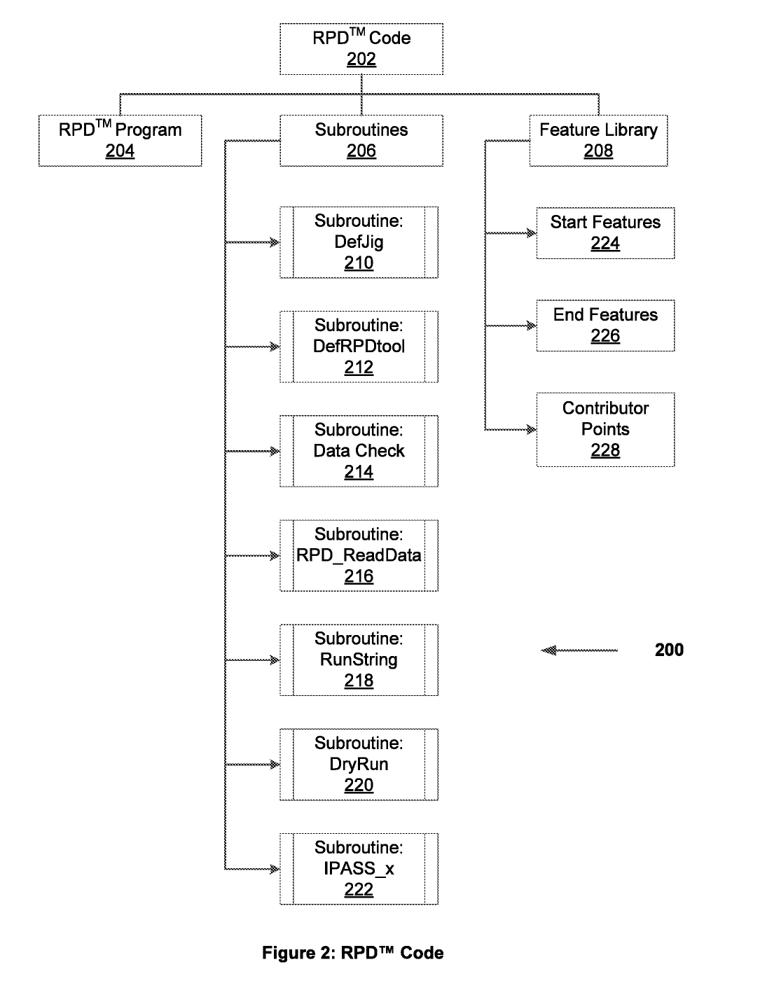

FIG. 2 is a block diagram of an embodiment of a logic architecture according to this disclosure. In particular, a logic architecture 200 includes a code 202 that calls a program 204, a subroutine group 206, and a feature library group 208. The architecture 200 in combination with a robustness of a rapid material deposition process and controlled disturbances from a rapid material deposition machine and a material enables a plurality of repeatable product properties. For example, the controlled disturbances from the rapid material deposition machine can include a wire tension in wire feeding, a wire feed speed accuracy, a deposition trajectory accuracy, a deposition speed accuracy, a deposition atmosphere with respect to water (H₂O) and oxygen dioxide (0₂), a torch plasma gas flow, a main current, a PTA current, a preheat current, or others. For example, the controlled disturbances from the material can include a wire feedstock variation, such as a diameter, a wire straightness, a wire rotation, a wire alloy, a wire density, or others. For example, the controlled disturbances from the material can include a substrate feedstock variation, such as a substrate thickness, a substrate surface roughness, a substrate straightness, or others. The controlled disturbances from the material can include a gas feedstock variation, such as for argon, an H₂O content, an 0₂ content, or others.

A configuration consistency across a plurality of rapid material deposition machines during a defined time period is maintained by a standardized calibration to a plurality of specifications of some, most, or all process critical machine elements. For example, the standardized calibration enables control of disturbances from the rapid material deposition machine, as mentioned above. The standardized calibration is a quality assurance (QA) procedure done on a schedule where a machine element, such as a controller, or a result of a material deposition process or a tool use are recorded. For example, such recordation can include a wire speed system parameter. For example, a routine that can be performed periodically, such as every 90 days, can include testing that a specified distance of wire is fed by specified speed during a specified time period. For example, some of the specifications can include a wire speed: a wire feed length variation in a speed mode of −0.3% to +0.3%, or a wire feed length variation in a position mode of −0.3% to +0.3%. While the above-noted variables are unit less, in at least one embodiment, the units are in mm. For example, some, most, or all data structures related to the specifications, such as tables or others, for every subsystem that is calibrated can be provided. For each of the subsystems, this can include a wire tension in a wire feeding, a wire feed speed variation, a deposition trajectory accuracy, a deposition speed accuracy, a deposition atmosphere with respect to H₂O and O₂, a torch plasma gas flow, a main current, a PTA current, a preheat current, or others. For example, some of the process critical machine elements can include a wire tension in a wire feeding, a wire feed speed accuracy, a deposition trajectory accuracy, a deposition speed accuracy, a deposition atmosphere with respect to H₂O and O₂, a torch plasma gas flow, a main current, a PTA current, a preheat current, or others. Furthermore, the above-noted tolerance of variables may vary variable to variable.

A plurality of fed-stock requirements, as mentioned above, are controlled by a receiving inspection and a standardized operation procedure (SOP). For example, the receiving inspection can include a standardized QA process describing how materials are received, checked, stored, or others. For example, an SOP can include a standardized QA process informative of how to insert a material, such as a metal or others, into a rapid material deposition machine, a cleaning of a rapid material deposition machine, on a use of gloves, or others.

The code 202 can be any type of code, such as source code, object code, or others. The code 202 can be standalone code or a part of an application, whether stored in a single locale or distributed among a plurality of locales. The code 202 can call the program 204, the subroutine group 206, or the feature library group 208 in any manner, such as via invoking or others. The code 202 is broken down into a plurality of programs that provide instructions for each workpiece, controlling welding temperature, positioning system and a process of pausing a manufacturing process, such as a welding process, to change a plurality of consumables on a deposition logic, whether hardware or software. The code 202 can communicably interface with a set of rapid plasma deposition recipes and then convert the set of rapid plasma deposition recipes into a set of data that an additive manufacturing machine can use to physically create a rapid plasma deposition form. Note that a rapid plasma deposition recipe from the set of rapid plasma deposition recipes can be a building block of the program 204. The rapid plasma deposition recipes are stored on the plasma welding controller 106. The program 204 calls on each individual recipe by using a numerical identifier, which can be unique.

Note that a process for rapidly depositing a material, such as a metal or others, is controlled via a master controller, such as the process master controller 104, which controls a plurality of set points to a plurality of process input controllers, such as a workpiece traverse speed, a deposition trajectory, a fed-stock rate, a heat input, or others. A plurality of process input variables are controlled following a plurality of trajectories in a Cartesian domain, such as an X, Y, Z space domain, coordinated in real-time, repeated by the program 204 in a fixed deposition schedule. For example, some of the process input variables that are controlled can include a wire tension in a wire feeding, a wire feed speed rate, a deposition speed, a torch plasma gas flow, a main current, a PTA current, a preheat current, a deposition atmosphere with respect to H₂O and O₂, or others. The process for rapidly depositing the material is controlled by the program 204 running on the master controller, which can be without an interaction from a human operator.

The program 204 is developed in a standardized gated work process. The program 204 utilizes a plurality of process monitoring sensors, such as via the process monitoring controller 108, to verify that the process for rapidly depositing the material is kept within a plurality of process windows throughout fabrication in a product development phase. Note that product quality is controlled by material property and geometric shape analysis. When the program 204, a set of process input parameters, and a trajectory schedule are finalized, then the program 204 is release controlled by configuration management. As such, the program 204, as released, can be loaded, such as via a flash drive, to a calibrated machine for rapidly depositing a material, such as a metal or others.

The subroutine group 206 includes a plurality of subroutines, including a Deflig subroutine 210, a DefRPDtool subroutine 212, a Data Check subroutine 214, an RFD_ReadData subroutine 216, a RunString subroutine 218, a DryRun subroutine 220, and an IPASS_x subroutine 222. Note that the subroutine group 206 is not limited to what is shown in FIG. 2 Rather, this configuration can be modified, such as via adding, editing, deleting, or others, for continuous developments of subroutines, feature types, or others. Each member of the subroutine group 206 is further described below. The feature library group 208 includes a plurality of data libraries, including a start features library 224, an end features library 226, and a contributor points library 228. For example, the feature library group 208 is a set of data, such as modules, data structures, or others, where a set of predefined recipe series, which is used to create specific structures on a deposition form, are stored.

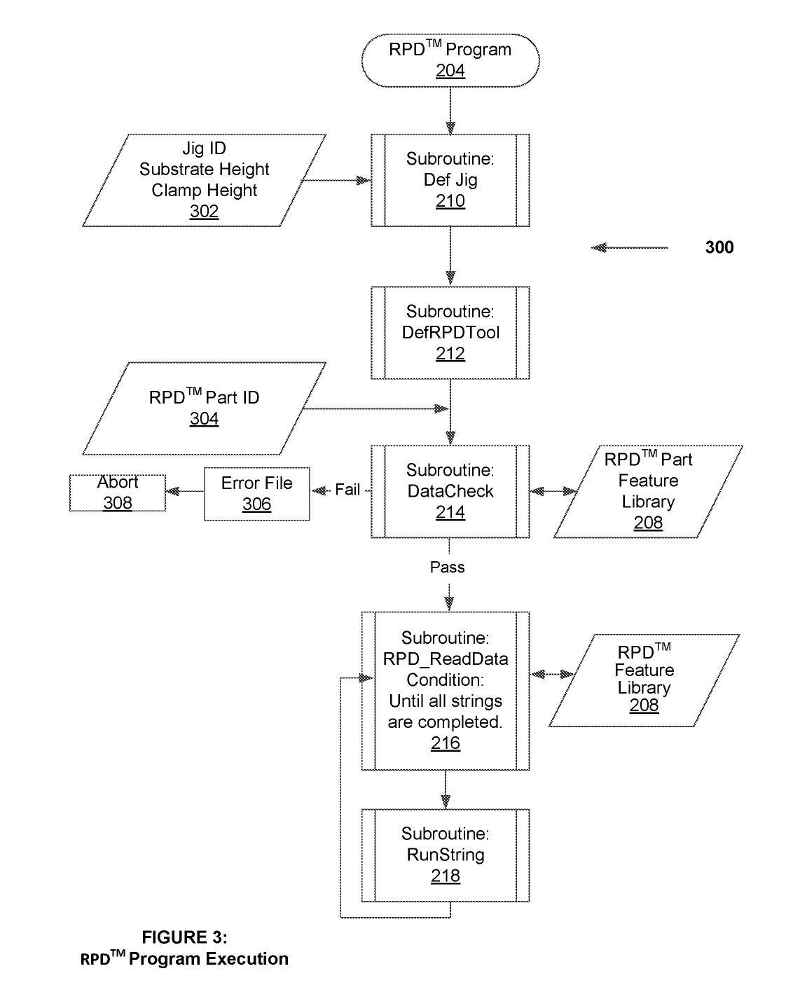

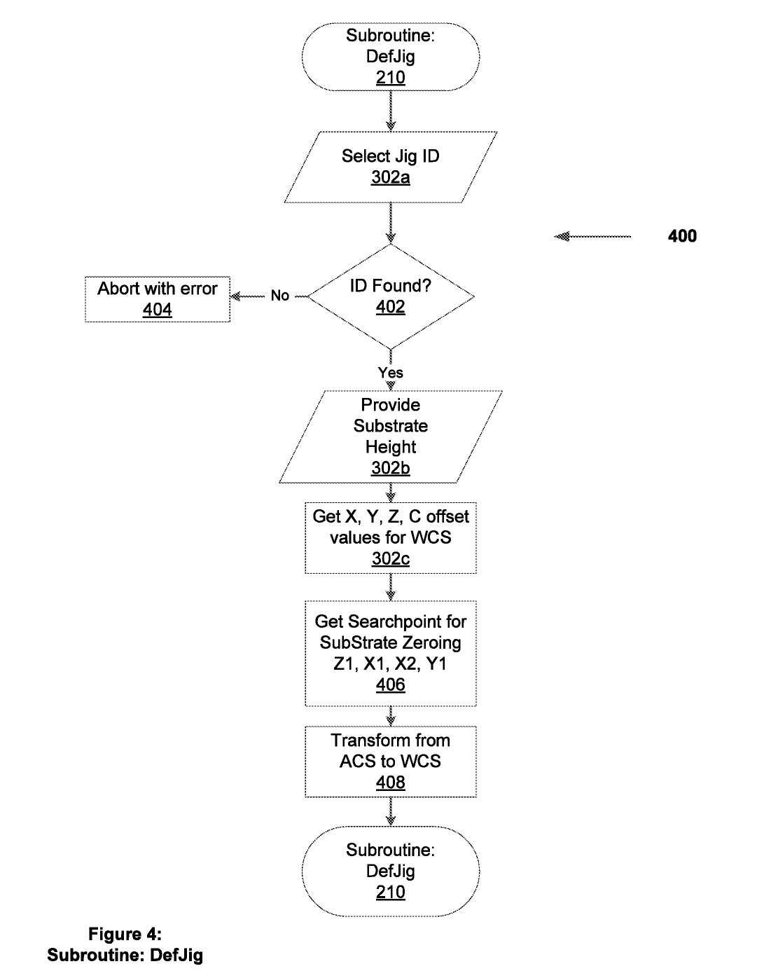

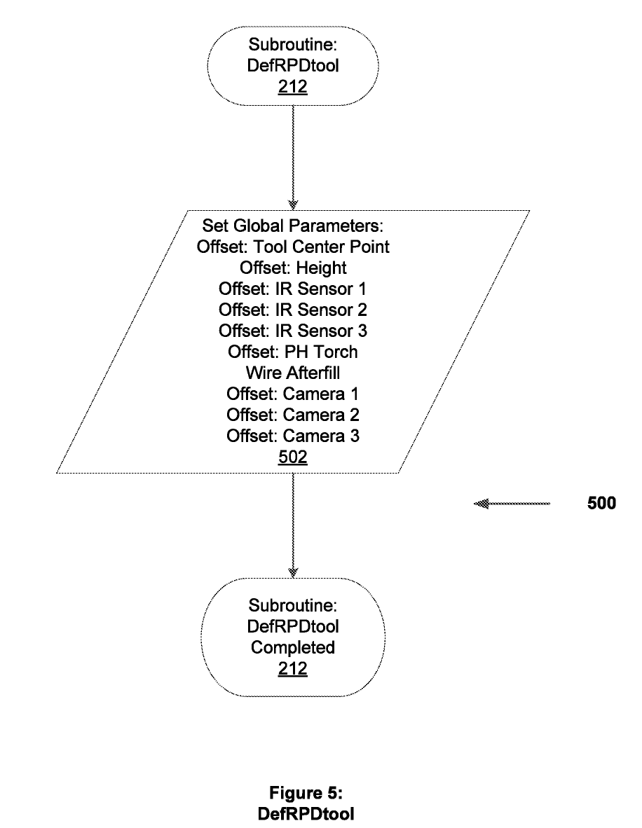

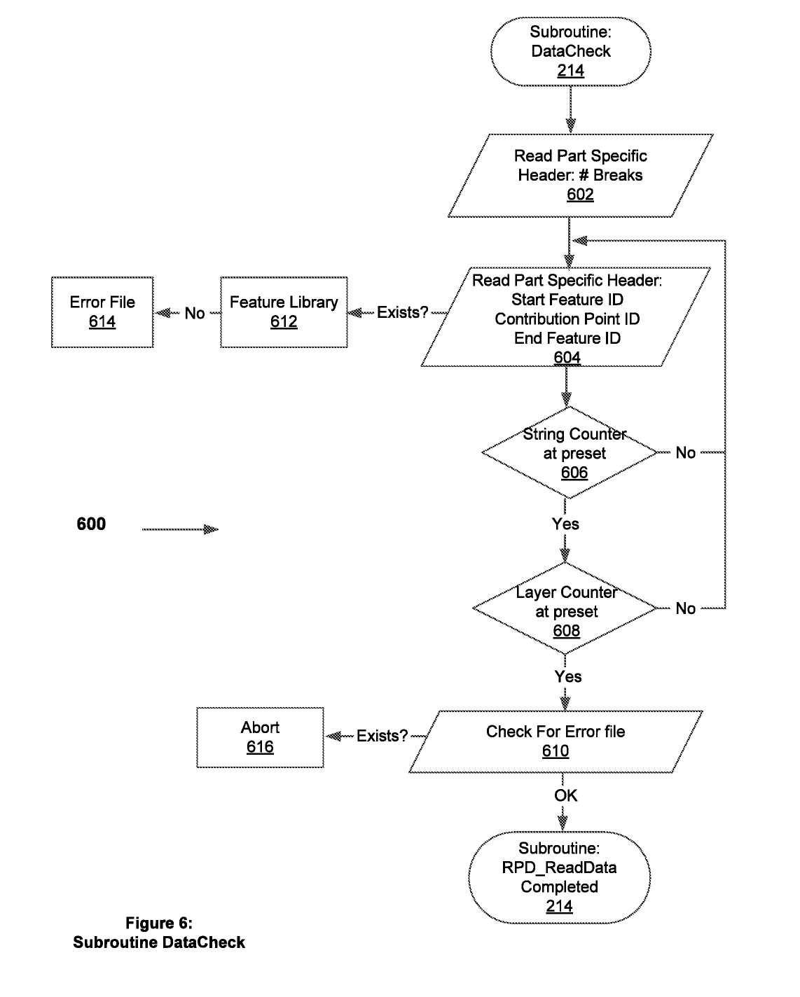

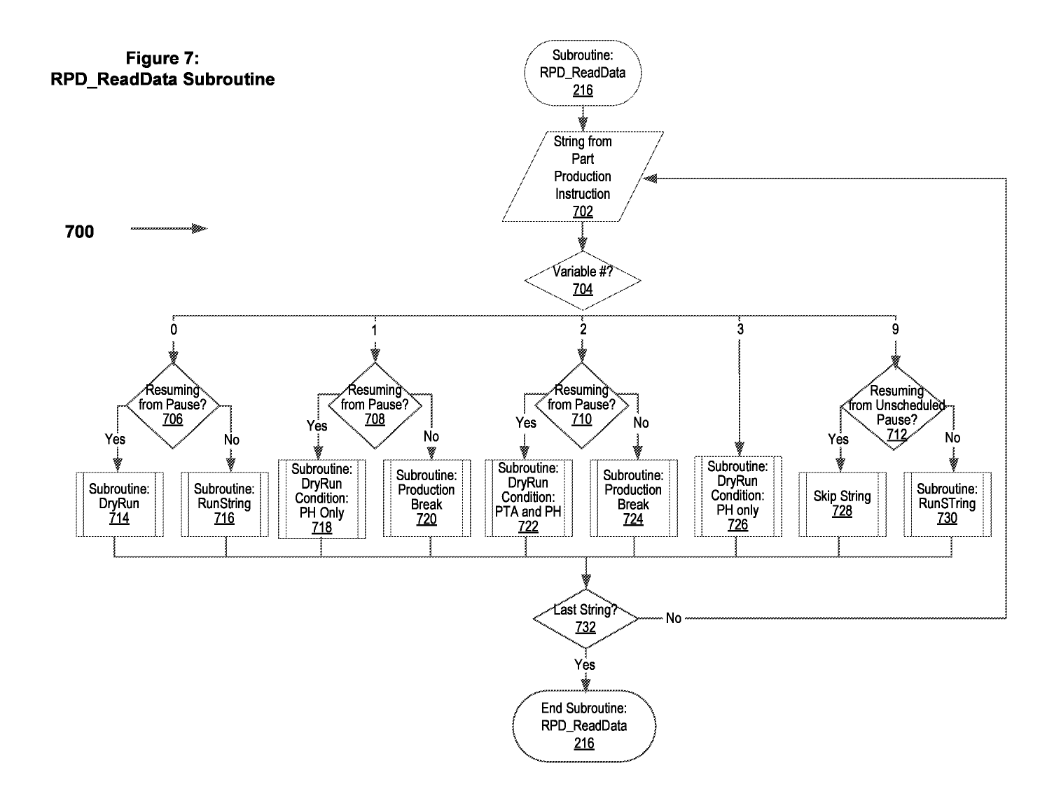

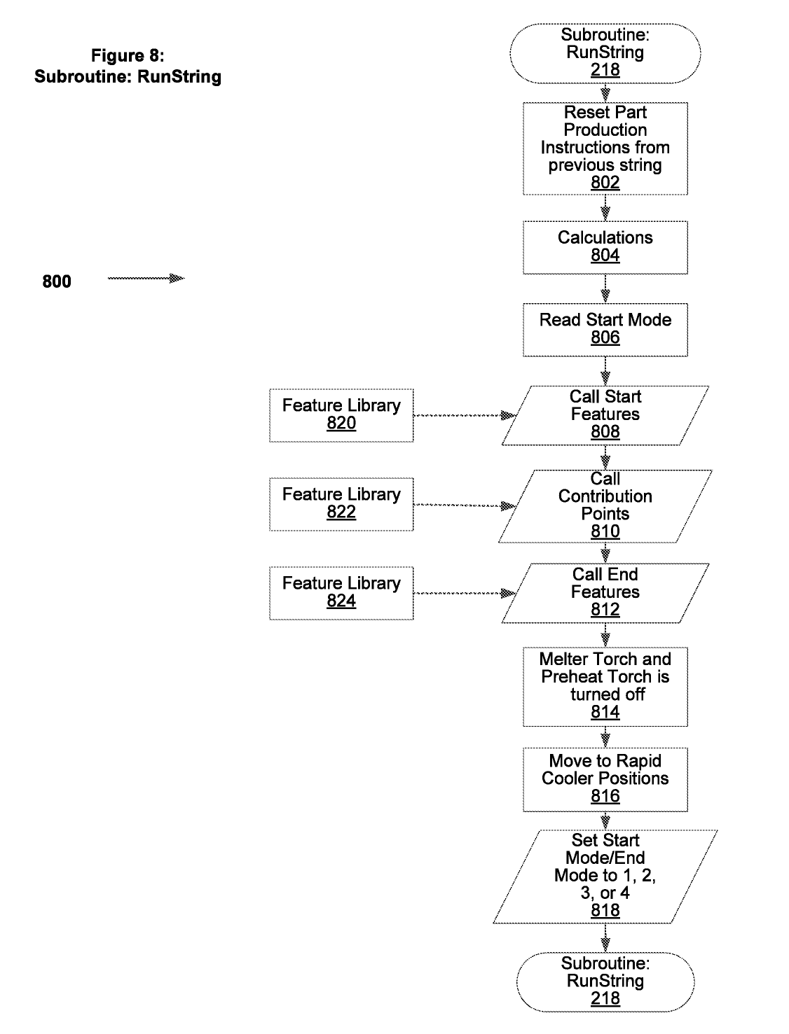

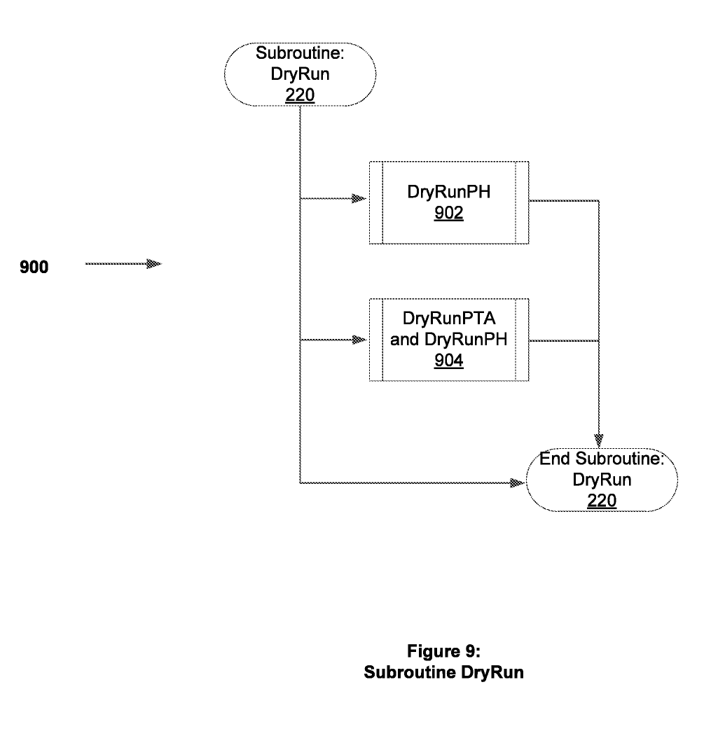

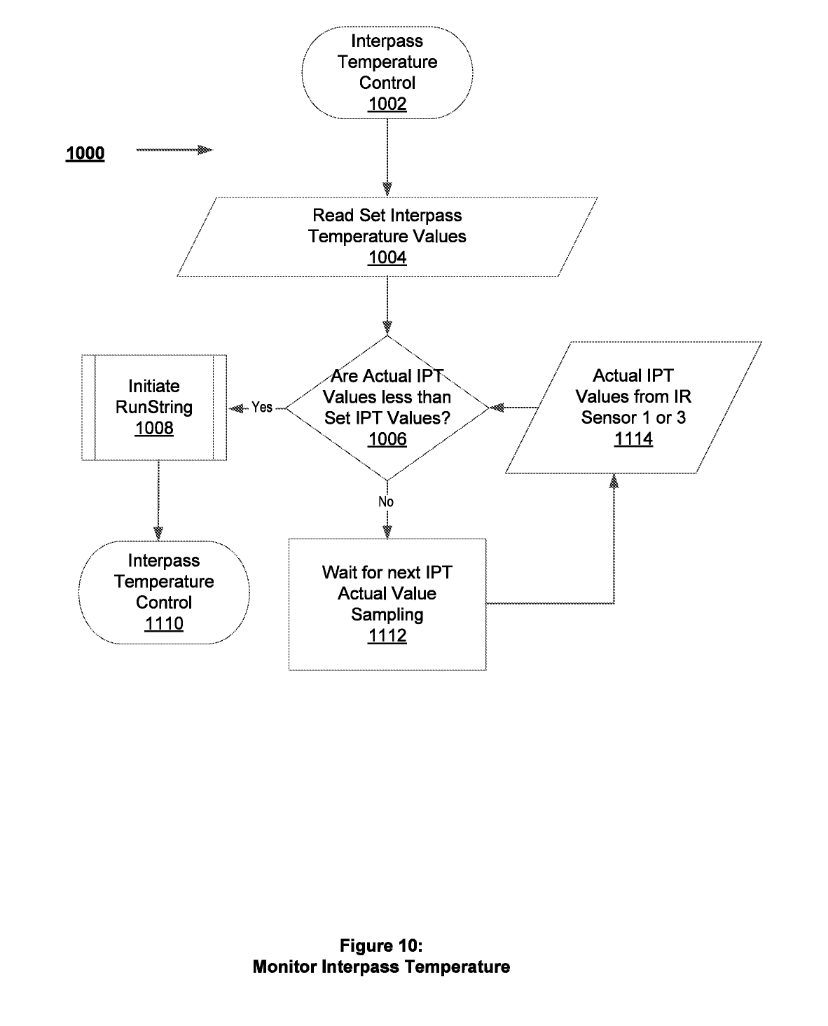

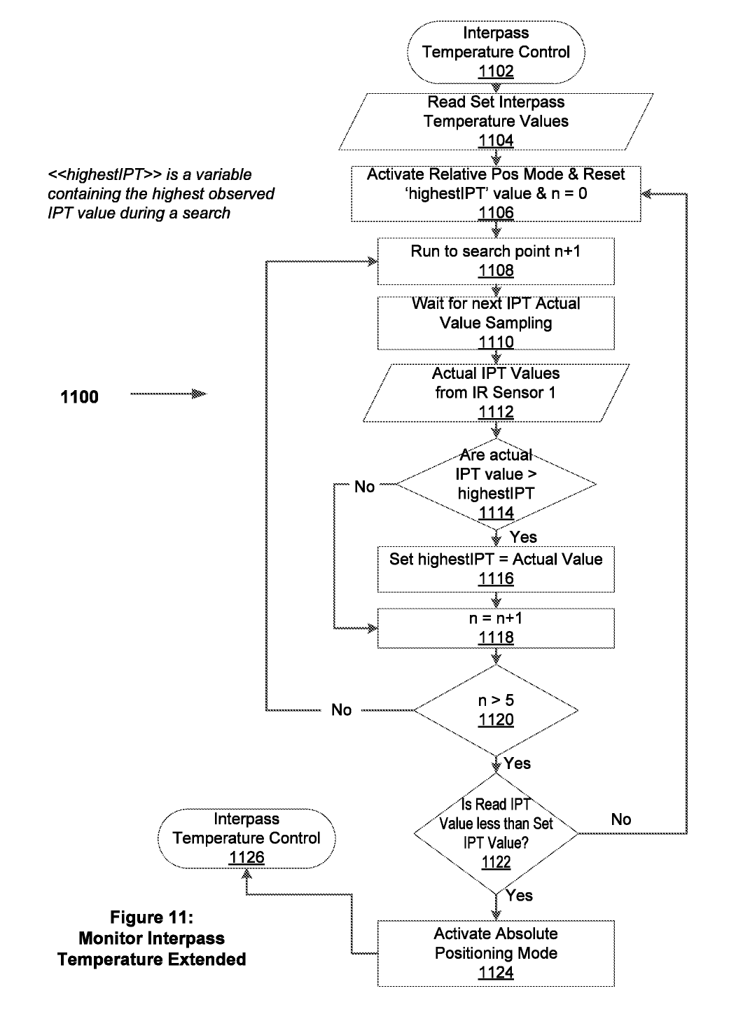

FIG. 3 is a flowchart of an embodiment of a process for executing a logic for additive manufacturing according to this disclosure. FIG. 4 is a flowchart of an embodiment of a define jig function process according to this disclosure. FIG. 5 is a flowchart of an embodiment of a define deposition tool function process according to this disclosure. FIG. 6 is a flowchart of an embodiment of a data check function process according to this disclosure. FIG. 7 is a flowchart of an embodiment of a read data function process according to this disclosure. FIG. 8 is a flowchart of an embodiment of a run string function process according to this disclosure. FIG. 9 is a flowchart of an embodiment of a dry run function process according to this disclosure. FIG. 10 is a flowchart of an embodiment of a temperature process according to this disclosure. FIG. 11 is a flowchart of an embodiment of a temperature process according to this disclosure.

As shown in FIG. 3, a process for additive manufacturing 300 employs the architecture 200 and uses a member of the subroutine group 206 and a member of the feature library group 208. In particular, the code 202, when executed via the process master controller 104, calls the program 204, which is executed via the process master controller 104 and defines a sequence of execution of various rapid plasma deposition process control elements. As such, as per the process 300, the program 204 invokes the subroutine 210, which is further described in FIG. 4, where an operator interfaces with the HMI control unit 110, as per a block 302, to instruct the process master controller 104 about a jig identifier (ID). Further, as per the block 302, the operator interfaces with the HMI control unit 110 to instruct the process master controller 104 about a substrate and a clamping height offset. In the subroutine 210, a relevant workpiece coordinate system for a rapid deposition process at hand is acquired.

Subsequently, as per the process 300, the program 204, as executed via the process master controller 104, invokes the subroutine 212, which is further described in FIG. 5, where the process master controller 104 receives or extracts a set of data about a geometric of a rapid plasma deposition tool, which is a logic, whether hardware or software, for a rapid plasma deposition process at hand and set a tool offset point of the rapid plasma deposition tool at a distance, such as 20.5 millimeters, above a substrate surface. Note that, as per a block 304, the operator interfaces with the HMI control unit 110 to instruct the process master controller 104 on a part ID that should be produced by a rapid plasma deposition machine. For example, the part ID can correspond to a workpiece to be manufactured, as disclosed herein.

Subsequently, as per the process 300, the program 204, as executed via the process master controller 104, invokes the subroutine 214, which is further described in FIG. 6, to gather, receive, or extract a set of rapid plasma deposition part programming instructions and relevant rapid plasma deposition features from the feature library group 208 for the part called by the operator through the HMI control unit 110, as noted above, and verify that some, most, or all information that is needed to complete a rapid plasma deposition process is accessibly available. Note that, as per a block 306 and a block 308, the subroutine 214 aborts the process 300 and stores an error message in a data structure, such as a file, an array, a log, a database, or others, whether local to or remote from the process master controller 104, if there are inputs missing in the code 202, at that point of execution.

Subsequently, as per the process 300, the program 204, as executed via the process master controller 104, invokes the subroutine 216, which is further described in FIG. 7 to read through and verify a set of data gathered by the subroutine 214. The subroutine 216 initiates the subroutine 218, which is further described in FIG. 8, if a set of instructions for a deposit string indicates that the deposit string should be deposited. For example, a deposit string can include a layer of deposited material, such as via a PTA torch melting a wire or others. Then, the subroutine 218 iterates back to the subroutine 216, until all string instructions have been executed.

As mentioned above, FIG. 4 illustrates the subroutine 210, which is used to define a size of a jig being used in a rapid plasma deposition process so that a rapid plasma deposition machine can adjust a workpiece coordinate system to accommodate for different sized jigs. In addition, the subroutine 210 contains a set of search points for a function that enables a substrate zeroing process. The subroutine 210 performs a process 400, some of which has been described above.

In a block 302a, the operator uses the HMI control unit 110 to instruct the process master controller 104 about the size of the jig by providing the jig ID of the jig that will be loaded into the rapid plasma deposition machine. For example, the jig ID can include an alphanumeric string.

In a block 402, the process master controller 104 validates the jig ID, such as via checking the jig ID against a set of IDs, whether in an alphanumeric or another format, which can involve format or type translation therebetween, such as via the process master controller 104.

If the jig ID cannot be validated, then a block 404 is performed, which includes an abort of the subroutine 210 and an output of a content, such as a message is displayed or an alarm is sounded. Otherwise, a block 302b is performed, where the operator uses the HMI control unit 110 to instruct the process master controller 104 about the substrate and clamp height offsets, as described above.

In a block 302c, the process master controller 104 sets the workpiece coordinate system (WCS) according to offsets, as locally retrieved, and adds a substrate height offset to a Z axis.

In a block 406, the process master controller 104 receives search points for a function substrate zeroing (Z1, X1, X2, Y1).

In a block 408, the process master controller 104 transforms an axis system from a Machine Axis Coordinate System (MACS) to the WCS with values provided from the block 302c. Subsequently, the process master controller 104 completes the subroutine 210.

As mentioned above, FIG. 5 illustrates the subroutine 212, which is used to provide a geometric of a rapid plasma deposition tool so that a rapid plasma deposition machine can adjust a process to accommodate for the geometric. The subroutine 212 performs a process 500, some of which has been described above. The process master controller 104 invokes the subroutine 212 once the process master controller 104 receives confirmation that the subroutine 210 is completed.

In a block 502, the subroutine 212 sets a global parameter tool center point offset, a global parameter height offset, a global parameter IR sensor 1 offset, a global parameter IR sensor 2 offset, a global parameter IR sensor 3 offset, a global parameter preheat torch offset, a global parameter wire Afterfill, a global parameter observatory automation system camera, such as a Chimera Camera 1 offset, a global parameter observatory automation system camera, such as a Chimera Camera 2 offset, and a global parameter observatory automation system camera, such as a Chimera Camera 3 offset.

As mentioned above, FIG. 6 illustrates the subroutine 214, which is used to retrieve a set of part programming instructions and relevant features from the library group 208 that the operator called through the HMI control unit 110 and verify that some, most, or all information that is needed to complete the rapid plasma deposition process is available. The subroutine 214 performs a process 600, some of which has been described above. The process master controller 104 invokes the subroutine 214 once the subroutine 212 is completed and the operator has entered the part ID, as per the block 304 of FIG. 3.

In a block 602, the process master controller 104 reads a number of scheduled strings and layers in a part instruction header and writes the part instruction header to a layer and string counter.

In a block 604, the process master controller 104 calls a string start feature ID in the part instruction header from the start features library 224. The process master controller 104 continues onto a block 606 if the start feature library 224 confirms that the string start feature ID is present. Otherwise, as per a block 612 and a block 614, the process master controller 104 aborts the process 600 and reports this error to a data structure, such as a file, an array, a database, or others, if the start feature library 224 does not confirm that the string start feature ID is present. Note that in the block 604, the process master controller 104 calls a contributing factor ID in the part instruction header from the start feature library 224. If the start features library 224 confirms that the contributing factor ID is present, then the block 606 is performed, otherwise, as per the block 612 and the block 614, the process master controller 104 aborts the process 600 and reports this error to a data structure, such as a file, an array, a database, or others. Similarly, the process master controller 104 calls a string end feature ID in the part instruction header from the end feature library 226. If the end features library 226 confirms that the string end feature ID is present, otherwise, as per the block 612 and the block 614, the process master controller 104 aborts the process 600 and reports this error to a data structure, such as a file, an array, a database, or others.

In a block 606, the process master controller 104 checks if a string counter is equal to set value, and if so, then the process master controller 104 increments a layer counter by 1.

In a block 608, the process master controller 104 checks if a layer counter is equal to set value. As such, if layer counter is lower than the set value, then the block 604 is performed, otherwise, a block 610 is performed if the layer counter equals set value. At this point, the process master controller 104 is informed that some, most, or all required information is available. However, if an error file is present after all layers are checked, then the process master controller 104 aborts the process 600 and an output with a content is presented at the HMI control unit 110, such as a message is displayed, an alarm is sounded or others.

As mentioned above, FIG. 7 illustrates the subroutine 216, which is used to read through and verify some, most, or all information gathered by the subroutine 214. The subroutine 216 performs a process 700, some of which has been described above. The process master controller 104 invokes the subroutine 216 after the subroutine 214 is completed and the operator has entered the part ID, as validated.

In a block 702, the process master controller 104 reads a first string from an part instruction.

In a block 704, the process master controller 104 calls out a variable and a range of parameters that provide instructions to an item on the rapid plasma deposition tool.

As per a set of blocks 706-730, the process master controller 104 initiates the subroutine 218 if the part instruction string calls variable 0. The process master controller 104 initiates the subroutine 220 with a condition of initiating a preheat torch only if the part instruction string calls variable 1 and the program 204 is resuming from a pause state. The process master controller 104 initiates a Break Subroutine if the part instruction string calls variable 1 and the program 204 is not resuming from a pause state. The process master controller 104 initiates the subroutine 220 with a condition of initiating a preheat torch and plasma transfer arch if the part instruction string calls variable 2 and the program 204 is resuming from a pause state. The process master controller 104 initiates the Break Subroutine if the part instruction string calls variable 2 and the program 204 is not resuming from a pause state. The process master controller 104 initiates the subroutine 220 with a condition of initiating a preheat torch only if the part instruction string calls variable 3. The process master controller 104 skips a string if the part instruction string calls variable 9 and the program 204 is resuming from a pause state. The process master controller 104 initiates the subroutine 220 if the part instruction string calls variable 9 and the program is not resuming from a pause state. The process master controller 104 checks whether there are more strings required to complete the part, and if there are no more strings, then subroutine 216 shall terminate.

As mentioned above, FIG. 8 illustrates the subroutine 218, which is used to execute deposition strings that shall be deposited on a substrate according to a set of part programming instructions. The subroutine 218 performs a process 800, some of which has been described above. The process master controller 104 invokes the subroutine 218 if the subroutine 216 has called a proper variable.

In a block 802, the process master controller 104 resets instructions from a previous string. For example, an end mode set during the previous string is a start mode for a new String.

In a block 804 and a block 806, the process master controller 104 calculates a set of positions along the string where a preheat torch, a melter torch, a PTA, a laser line sensor, a set of IR sensors 1, 2, and 3, and a rapid cooler will stop and start.

In a block 808 and a block 820, the process master controller 104 calls a string start feature from the features library 224.

In a block 810 and a block 822, the process master controller 104 calls a set of contribution points from the features library 224.

In a block 812 and a block 824, the process master controller 104 calls a string end features from the features library 224.

In a block 814, the process master controller 104 turns off the preheater torch, the melter torch, and the PTA.

In a block 816, the process master controller 104 moves the preheater torch, the melter torch, and the PTA to a set of rapid cooler positions.

In a block 818, the process master controller 104 sets a start mode for a next string. The process master controller 104 will conduct a regular start if the start mode is set to 1. The process master controller 104 will continue deposition of a string at an end of the string, and a C-axis will adjust a set of coordinates of the next string if the start mode is set to 2. The process master controller 104 will continue deposition of a string at an end of the string, and the C-axis will not adjust a set of coordinates of the next string if the start mode is set to 3. The process master controller 104 will continue deposition in a circular movement at an end of a String and to a beginning of the next string if the start mode is set to 4. Then, the subroutine 218 terminates.

As mentioned above, FIG. 9 illustrates the subroutine 220, which is used to execute a deposition string that shall not be deposited on a substrate according to a set of part programming instructions. For example, the subroutine 220 can enable manufacturing simulation. The subroutine 220 performs a process 900, some of which has been described above. The process master controller 104 invokes the subroutine 220 if the subroutine 216 has called a proper variable.

In a block 902, the process master controller 104 initiates a preheat torch if the subroutine 216 initiates variable 3, or initiates variable 2 and a deposition tool is resuming from a pause mode.

In a block 904, the process master controller 104 initiates a preheat torch and a PTA if the subroutine 216 initiates variable 2 and a deposition tool is resuming from a pause mode. Then, the subroutine 220 terminates.

As mentioned above, FIG. 10 illustrates a temperature process 1000, which can be a subroutine in the subroutines 206 and is used to check a measured interpass temperature value from a set of IR sensors against a set of permitted interpass temperature values in order to ensure quality control during a material deposition process to manufacture a part. The process master controller 104 initiates the process 1000 and can perform the process 1000 when the process master controller 104 receives a string of a set of part-production parameters from the subroutine 218. The process 1000 includes a set of blocks 1002-1114 and is initiated at the block 1002.

In the block 1004, the process master controller 104 reads a set of interpass temperature values.

In the block 1006, the process master controller 104 reads a set of actual interpass temperature values from IR sensor 1 or IR sensor 3, as per the block 1114, and compares the set of actual interpass temperature values against a permitted range defined in the set of interpass temperature values of the block 1004.

In the block 1008, the process master controller 104 initiates the subroutine 218 if the set of actual interpass temperature values are within, such as lower, the permitted range defined in set of interpass values. Note that such comparison can occur on a one-by-one basis, such as comparing one value at a time. Subsequently, the process 1000 terminates. Otherwise, as per the block 1112, the process master controller 104 awaits a next reading of an actual interpass temperature if the values are outside the permitted range defined in the set of interpass values. The process master controller 104 awaits further instructions from the subroutine 218.

As mentioned above, FIG. 11 illustrates a temperature process 1100, which can be a subroutine in the subroutines 206 and is used to check a measured interpass temperature value from an IR Sensor 1 against a permitted interpass temperature values in order to ensure quality control during a material deposition process to manufacture a part. Note that prior to comparing various temperature values, the process 1100 does a search to find a highest temperature in a defined area. The process 1100 includes a set of blocks 1102-1126 and is initiated at the block 1102. The process master controller 104 initiates the process 1100 and can perform the process 1100 when the process master controller 104 receives a string of a part-production parameter from the subroutine 218.

In the block 1104, the process master controller 104 reads a set of interpass temperature values.

In the block 1106, the process master controller 104 activates a relative positioning command in a controller, as disclosed herein. For example, such controller can include the plasma welding controller 106. The process master controller 104 resets a local variable corresponding to a highest interpass temperature. The process master controller 104 resets a search point counter n.

In the block 1108, the process master controller 104 runs a rapid plasma deposition tool to search point n+1.

In the block 1110, the process master controller 104 waits for a next interpass temperature reading from an IR sensor.

In the block 1112, the process master controller 104 reads an actual value from the IR sensor.

In the block 1114, the process master controller 104 compares the value read against the highest interpass temperature value. If the actual value is higher than the highest interpass temperature value, then the process master controller 104 saves a new value to a highest interpass temperature value, as per the block 1116, and then proceeds to the block 1118, otherwise, if the actual value is smaller or equal to the highest interpass temperature value, then the process 1100 proceeds to the block 1118.

In the block 1118, the process master controller 104 adds 1 to the search point counter n.

In the block 1120, the process master controller 104 determines that if the search point counter n is higher than 5, then the process master controller 104 performs the block 1122, otherwise, if the search point counter n is smaller or equal to 5, then the process master controller 104 proceeds to the block 1108.

In the block 1122, the process master controller 104 compares the highest interpass temperature value against the permitted range defined in the set of interpass temperature values. If the highest interpass temperature value is within the permitted range defined in the set of interpass temperature values, then, as per the block 1124, the process master controller 104 activates absolute positioning command to the controller, otherwise, if the highest interpass temperature values are outside the permitted range defined in the set of interpass temperature values, then the process master controller 104 proceeds to the block 1106. The process master controller 104 awaits further instructions from the subroutine 218.

Various embodiments of this disclosure can be implemented in a data processing system suitable for storing and/or executing program code that includes at least one processor coupled directly or indirectly to memory elements through a system bus. The memory elements include, for instance, local memory employed during actual execution of the program code, bulk storage, and cache memory which provide temporary storage of at least some program code in order to reduce the number of times code must be retrieved from bulk storage during execution.

I/O devices (including, but not limited to, keyboards, displays, pointing devices, DASD, tape, CDs, DVDs, thumb drives and other memory media, etc.) can be coupled to the system either directly or through intervening I/O controllers. Network adapters can also be coupled to the system to enable the data processing system to become coupled to other data processing systems or remote printers or storage devices through intervening private or public networks. Modems, cable modems, and Ethernet cards are just a few of the available types of network adapters.

This disclosure can be embodied in a system, a method, and/or a computer program product. The computer program product can include a computer readable storage medium (or media) having computer readable program instructions thereon for causing a processor to carry out aspects of the present disclosure. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing.

Computer readable program instructions described herein can be downloaded to respective computing/processing devices from a computer readable storage medium or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure can be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. A code segment or machine-executable instructions can represent a procedure, a function, a subprogram, a program, a routine, a subroutine, a module, a software package, a class, or any combination of instructions, data structures, or program statements. A code segment can be coupled to another code segment or a hardware circuit by passing and/or receiving information, data, arguments, parameters, or memory contents. Information, arguments, parameters, data, etc. can be passed, forwarded, or transmitted via any suitable means including memory sharing, message passing, token passing, network transmission, among others. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a LAN or a WAN, or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of this disclosure.

Aspects of this disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions. The various illustrative logical blocks, modules, circuits, and algorithm steps described in connection with the embodiments disclosed herein can be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans can implement the described functionality in varying ways for each particular application, but such implementation decisions should not be interpreted as causing a departure from the scope of this disclosure.

The flowchart and block diagrams in the Figures illustrate the architecture, functionality, and operation of possible implementations of systems, methods, and computer program products according to various embodiments of the present disclosure. In this regard, each block in the flowchart or block diagrams can represent a module, segment, or portion of instructions, which comprises one or more executable instructions for implementing the specified logical function(s). In some alternative implementations, the functions noted in the block can occur out of the order noted in the figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Words such as “then,” “next,” etc. are not intended to limit the order of the steps; these words are simply used to guide a reader through the description of the methods. Although process flow diagrams can describe the operations as a sequential process, many of the operations can be performed in parallel or concurrently. In addition, the order of the operations can be re-arranged. A process can correspond to a method, a function, a procedure, a subroutine, a subprogram, etc. When a process corresponds to a function, its termination can correspond to a return of the function to the calling function or the main function.

Features or functionality described with respect to certain embodiments can be combined and sub-combined in and/or with various other embodiments. Also, different aspects and/or elements of embodiments, as disclosed herein, can be combined and sub-combined in a similar manner as well. Further, some embodiments, whether individually and/or collectively, can be components of a larger system, wherein other procedures can take precedence over and/or otherwise modify their application. Additionally, a number of steps can be required before, after, and/or concurrently with embodiments, as disclosed herein. Note that any and/or all methods and/or processes, at least as disclosed herein, can be at least partially performed via at least one entity or actor in any manner.

The terminology used herein can imply direct or indirect, full or partial, temporary or permanent, action or inaction. For example, when an element is referred to as being “on,” “connected” or “coupled” to another element, then the element can be directly on, connected or coupled to the other element and/or intervening elements can be present, including indirect and/or direct variants. In contrast, when an element is referred to as being “directly connected” or “directly coupled” to another element, there are no intervening elements present.

Although the terms first, second, etc. can be used herein to describe various elements, components, regions, layers and/or sections, these elements, components, regions, layers and/or sections should not necessarily be limited by such terms. These terms are used to distinguish one element, component, region, layer or section from another element, component, region, layer or section. Thus, a first element, component, region, layer, or section discussed below could be termed a second element, component, region, layer, or section without departing from the teachings of this disclosure.

The terminology used herein is for describing particular embodiments and is not intended to be necessarily limiting of this disclosure. As used herein, the singular forms “a,” “an” and “the” are intended to include the plural forms as well, unless the context clearly indicates otherwise. Also, as used herein, the term “a” and/or “an” shall mean “one or more,” even though the phrase “one or more” is also used herein. The terms “comprises,” “includes” and/or “comprising,” “including” when used in this specification, specify the presence of stated features, integers, steps, operations, elements, and/or components, but do not preclude the presence and/or addition of one or more other features, integers, steps, operations, elements, components, and/or groups thereof. Furthermore, when this disclosure states herein that something is “based on” something else, then such statement refers to a basis which can be based on one or more other things as well. In other words, unless expressly indicated otherwise, as used herein “based on” inclusively means “based at least in part on” or “based at least partially on.”

As used herein, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances.

Unless otherwise defined, all terms (including technical and scientific terms) used herein have same meaning as commonly understood by one of ordinary skill in the art to which this disclosure belongs. The terms, such as those defined in commonly used dictionaries, should be interpreted as having a meaning that is consistent with their meaning in the context of the relevant art and should not be interpreted in an idealized and/or overly formal sense unless expressly so defined herein.

As used herein, the term “about” and/or “substantially” refers to a +/−10% variation from the nominal value/term. Such variation is always included in any given.

If any disclosures are incorporated herein by reference and such disclosures conflict in part and/or in whole with this disclosure, then to an extent of conflict, and/or broader disclosure, and/or broader definition of terms, this disclosure controls. If such disclosures conflict in part and/or in whole with one another, then to an extent of conflict, the later-dated disclosure controls.

It will be apparent to skilled artisans that various modifications and variation can be made in this disclosure without departing from a spirit or scope thereof. Thus, it is intended that this disclosure cover modifications and variations thereof, provided that such modifications and the variations come within a scope of the claims, as recited below, and their equivalents.

What is claimed is:

1. A method comprising:
executing, by a process master controller (104), a program (204) configured to access a plurality of subroutines (206) and a plurality of libraries (208);
invoking, by the process master controller, via the program, a first subroutine (210) of the subroutines, wherein the first subroutine provides the program with a set of axis data with a plurality of offset values in accordance with a workpiece coordinate system (WCS);
invoking, by the process master controller, via the program, a second subroutine (212) of the subroutines, wherein the second subroutine provides the program with a set of geometric data about a geometric of an additive manufacturing tool for an additive manufacturing process and sets a tool offset point of the additive manufacturing tool at a distance above a substrate surface;
receiving, by the process master controller, via the program, a workpiece identifier from an HMI (110);
invoking, by the process master controller, via the program, a third subroutine (214) of the subroutines, wherein the third subroutine provides the program with a set of rapid plasma deposition part programming instructions and a set of rapid plasma deposition features from one of the libraries based on the workpiece identifier;
invoking, by the process master controller, via the program, a fourth subroutine (216) of the subroutines, wherein the fourth subroutine verifies the set of rapid plasma deposition part programming instructions and the set of rapid plasma deposition features;
invoking, by the process master controller, via the program, a fifth subroutine (218) of the subroutines, wherein the fifth subroutine enables the program to request an additive manufacturing system to deposit a layer on the substrate surface by the additive manufacturing tool via the additive manufacturing process; and
depositing the layer on the substrate surface with the additive manufacturing tool, under the control of the process master controller, in response to the additive manufacturing system request.

2. The method of claim 1, wherein the additive manufacturing process includes melting a wire via a torch in a cloud of an inert gas.

3. The method of claim 1, further comprising:
invoking, by the process master controller, via the program, the fourth subroutine after the layer has been deposited such that another layer can be deposited based on the set of rapid plasma deposition part programming instructions and the set of rapid plasma deposition features.

4. The method of claim 1, wherein the program is configured to receive an input from a user via the HMI, wherein the input is configured to request a simulation of the additive manufacturing system depositing the layer on the substrate surface by the additive manufacturing tool via the additive manufacturing process, and further comprising:
receiving, by the process master controller, via the program, the input from the HMI; and
performing, by the process master controller, the simulation.

5. The method of claim 1, wherein the additive manufacturing system deposits the layer on the substrate surface by the additive manufacturing tool via the additive manufacturing process without relying on an active feedback from a sensor.

6. The method of claim 1, wherein the program is specific a workpiece based on the workpiece identifier.

7. The method of claim 1, wherein the workpiece identifier is received without invoking the subroutines.

8. The method of claim 1, wherein at least one of the libraries is remote from the process master controller.

9. The method of claim 1, further comprising:
aborting, by the process master controller, the program during the third subroutine based on the program not being provided with the set of axis data with the plurality of offset values in accordance with the WCS, the set of geometric data about the geometric the additive manufacturing tool for the additive manufacturing process, and the workpiece identifier at that time.

10. The method of claim 1, wherein the additive manufacturing system deposits the layer on the substrate surface by the additive manufacturing tool via the additive manufacturing process based on:
resetting from a previous layer, and
determining a set of positions along the layer where a preheat torch, a melter torch, a PTA, and a rapid cooler in the additive manufacturing system will stop and start.

11. A system comprising:
an HMI (110);
a process master controller (104) configured to:
execute a program (204) configured to access a plurality of subroutines (206) and a plurality of libraries (208);
invoke, via the program, a first subroutine (210) of the subroutines, wherein the first subroutine provides the program with a set of axis data with a plurality of offset values in accordance with a workpiece coordinate system (WCS);
invoke, via the program, a second subroutine (212) of the subroutines, wherein the second subroutine provides the program with a set of geometric data about a geometric of an additive manufacturing tool for an additive manufacturing process and sets a tool offset point of the additive manufacturing tool at a distance above a substrate surface;
receive, via the program, a workpiece identifier from the HMI;
invoke, via the program, a third subroutine (214) of the subroutines, wherein the third subroutine provides the program with a set of rapid plasma deposition part programming instructions and a set of rapid plasma deposition features from one of the libraries based on the workpiece identifier;
invoke, via the program, a fourth subroutine (216) of the subroutines, wherein the fourth subroutine verifies the set of rapid plasma deposition part programming instructions and the set of rapid plasma deposition features; and
invoke, via the program, a fifth subroutine (218) of the subroutines, wherein the fifth subroutine enables the program to request an additive manufacturing system to deposit a layer on the substrate surface by the additive manufacturing tool via the additive manufacturing process.

12. The system of claim 11, wherein the additive manufacturing process includes melting a wire via a torch in a cloud of an inert gas.

13. The system of claim 11, wherein the process master controller is further configured to:
invoke, via the program, the fourth subroutine after the layer has been deposited such that another layer can be deposited based on the set of rapid plasma deposition part programming instructions and the set of rapid plasma deposition features.

14. The system of claim 11, wherein the program is configured to receive an input from a user via the HMI, wherein the input is configured to request a simulation of the additive manufacturing system depositing the layer on the substrate surface by the additive manufacturing tool via the additive manufacturing process, and the process master controller is further configured to:
receive, via the program, the input from the HMI; and
perform the simulation.

15. The system of claim 11, wherein the additive manufacturing system deposits the layer on the substrate surface by the additive manufacturing tool via the additive manufacturing process without relying on an active feedback from a sensor.

16. The system of claim 11, wherein the program is specific a workpiece based on the workpiece identifier.

17. The system of claim 11, wherein the workpiece identifier is received without invoking the subroutines.

18. The system of claim 11, wherein at least one of the libraries is remote from the process master controller.

19. The system of claim 11, wherein the process master controller is further configured to:
abort the program during the third subroutine based on the program not being provided with the set of axis data with the plurality of offset values in accordance with the WCS, the set of geometric data about the geometric the additive manufacturing tool for the additive manufacturing process, and the workpiece identifier at that time.

20. The system of claim 11, wherein the additive manufacturing system deposits the layer on the substrate surface by the additive manufacturing tool via the additive manufacturing process based on:
resetting from a previous layer, and
determining a set of positions along the layer where a preheat torch, a melter torch, a PTA, and a rapid cooler in the additive manufacturing system will stop and start.
